(19) United States
(12) Patent Application Publication
(10) Pub. No.: US 2004/0233246 A1
(43) Pub. Date: Nov. 25, 2004

(54) Recording position correction method, an inkjet type recording apparatus and a computer program

(75) Inventor: Atsuhiko Takeushi, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/796,167

(22) Filed: Mar. 10, 2004

Related U.S. Application Data
(63) Continuation-in-part of application No. PCT/JP03/11007, filed on Aug. 29, 2003.

(30) Foreign Application Priority Data
Aug. 29, 2002 (JP) 2002-251882
Aug. 28, 2003 (JP) 2003-304020

(51) Int. Cl. B41J 29/393

(52) U.S. Cl. 347/19

(57) ABSTRACT

A method for correcting position deviation in a sub-scanning direction crossing a main scanning direction of a recording position on a medium to be recorded 11 in regard to an inkjet type recording apparatus 10 includes an ejection step of ejecting the ink from the plurality of nozzles onto the medium to be recorded 11, a measurement step of measuring an amount of position deviation in the sub-scanning direction of an ink dot recorded and a correction step of previously shifting and correcting a recording position of an ink dot to be recorded on the medium 11 for each of the plurality of nozzles based on the measured amount of the position deviation.

The present application is a continuation application of PCT/JP03/11007 filed on Aug. 29, 2003, which claims priority from Japanese patent applications Nos. 2002-251882 filed on Aug. 29, 2002 and 2003-304020 filed on August 28 2003, the entire contents of which are incorporated herein by reference for all purposes.

### BACKGROUND OF THE INVENTION

1. Field of the Invention

The present invention relates to a recording position correction method, an inkjet type recording apparatus and a computer program therefor. More particularly, the present invention relates to a recording position correction method, an inkjet type recording apparatus and a computer program capable of making up for the deviation of the recording position due to the mounting direction of a recording head.

2. Related Art

An inkjet type recording apparatus performs recording on a medium to be recorded by ejecting ink from a plurality of nozzles while allowing a carriage including a recording head on which nozzle arrays consisting of a plurality of nozzles, which are provided in a sub-scanning direction, are arranged in a main scanning direction to perform a scanning operation along at least either a forward or backward path in the main scanning direction as disclosed, for example, in a Japanese Patent Application Publication No. JPA 11-348250.

In the inkjet type recording apparatus, the carriage might be mounted on a guide which is designed to support the carriage while the carriage is angled with respect to the guide. In addition, if the carriage is not mounted on the guide in a good state, the carriage might cause so called a chattering while the recording head performs scanning at least either back or forth in the main scanning direction. If the recording head is not positioned at exact accuracy with respect to the medium to be recorded in the inkjet type recording apparatus, it is impossible to perform desired recording.

### SUMMARY OF THE INVENTION

Accordingly, it is an object of the present invention to provide a recording position correction method, an inkjet type recording apparatus and a computer program therefor, which is capable of overcoming the above drawbacks accompanying the conventional apparatus or system. The above and other objects can be achieved by combinations described in the independent claims. The dependent claims define further advantageous and exemplary combinations of the present invention.

In order to solve the problems above, according to the first aspect of the present invention, a recording position correction method for correcting position deviation in a sub-scanning direction crossing a main scanning direction of a recording position on a medium to be recorded, wherein an inkjet type recording apparatus performs recording on the medium to be recorded by ejecting ink from a plurality of nozzles while allowing a recording head, on which nozzle arrays including the plurality of nozzles provided in the sub-scanning direction are arranged in the main scanning direction, to perform scanning along at least one of forward and backward paths in the main scanning direction, includes an ejection step of ejecting the ink from the plurality of nozzles onto the medium to be recorded, a measurement step of measuring an amount of position deviation in the sub-scanning direction of an ink dot recorded and a correction step of previously shifting and correcting a recording position of an ink dot to be recorded on the material for each of the plurality of nozzles based on the measured amount of the position deviation.

The ink may be ejected from at least one nozzle of each of two nozzle arrays most distanced from each other in the main scanning direction among the plurality of nozzle arrays in the ejection step, and the recording position of the ink dot to be recorded on the material for each of the plurality of nozzles may be previously shifted and corrected based on an amount of position deviation of an ink dot ejected and recorded from the nozzle of the two nozzle arrays in the correction step.

The ink may be further ejected from a nozzle of a nozzle array among the plurality of nozzle arrays except the two nozzle arrays in the ejection step, and the recording position of the ink dot to be recorded on the material for each of the plurality of nozzles may be previously shifted and corrected based on an amount of position deviation of an ink dot ejected and recorded from at least one nozzle of each of the two nozzle arrays and at least one nozzle of the nozzle array except the two nozzle arrays in the correction step.

The ink may be ejected from the plurality of nozzles in order that a color of the ink from each of the nozzle arrays is different from one another in the ejection step, and the recording position of the ink dot may be previously shifted and corrected for each of the colors in the correction step.

The ink may be ejected while the recording head performs scanning along the forward and/or backward path(s) in the main scanning direction in the ejection step, and the recording position of the ink dot may be previously shifted and corrected in the correction step based on an intermediate value between an amount of position deviation of an ink dot ejected and recorded in case the ink is ejected while the recording head performs scanning along the forward path in the main scanning direction and an amount of position deviation of an ink dot ejected and recorded in case the ink is ejected while the recording head performs scanning along the backward path.

The ink may be ejected while the recording head performs scanning along the forward and/or backward path(s) in the main scanning direction in the ejection step, and the correction may be performed in the correction step, wherein the recording position of an ink dot to be recorded along the forward path in the main scanning direction may be previously shifted based on an amount of position deviation in case the recording head performs scanning along the forward path in the main scanning direction and the recording position of an ink dot to be recorded along the backward path may be previously shifted based on an amount of position deviation in case the recording head performs scanning along the backward path.

The ink may be ejected from at least one nozzle of each of two nozzle arrays which eject the ink of two colors respectively among the plurality of nozzle arrays as priority is given to a color of which density is highest in the ejection step, and the recording position of the ink dot to be recorded on the material for each of the plurality of nozzles may be previously shifted and corrected based on an amount of position deviation of an ink dot ejected and recorded from the nozzle of the two nozzle arrays in the correction step.

According to the second aspect of the present invention, an inkjet type recording apparatus for performing recording on the medium to be recorded by ejecting ink from a plurality of nozzles while allowing a recording head, on which nozzle arrays including the plurality of nozzles provided in the sub-scanning direction are arranged in the main scanning direction, to perform scanning along at least one of forward and backward paths in the main scanning direction, includes a correcting unit for previously shifting and correcting a recording position of an ink dot to be recorded on the material for each of the plurality of nozzles based on an amount of position deviation in a sub-scanning direction crossing the main scanning direction of an ink dot ejected and recorded from the plurality of nozzles.

According to the third aspect of the present invention, a computer program for correcting position deviation of an ink dot ejected and recorded from a plurality of nozzles in a sub-scanning direction crossing a main scanning direction, wherein an inkjet type recording apparatus performs recording on a medium to be recorded by ejecting ink from the plurality of nozzles while allowing a recording head, on which nozzle arrays including the plurality of nozzles provided in the sub-scanning direction are arranged in the main scanning direction, to perform scanning along at least one of forward and backward paths in the main scanning direction, includes a correction function of correcting previously shifting and correcting a recording position of an ink dot to be recorded on the material for each of the plurality of nozzles based on an amount of position deviation of an ink dot ejected and recorded from the plurality of nozzles in the sub-scanning direction crossing the main scanning direction.

### BRIEF DESCRIPTION OF THE INVENITON

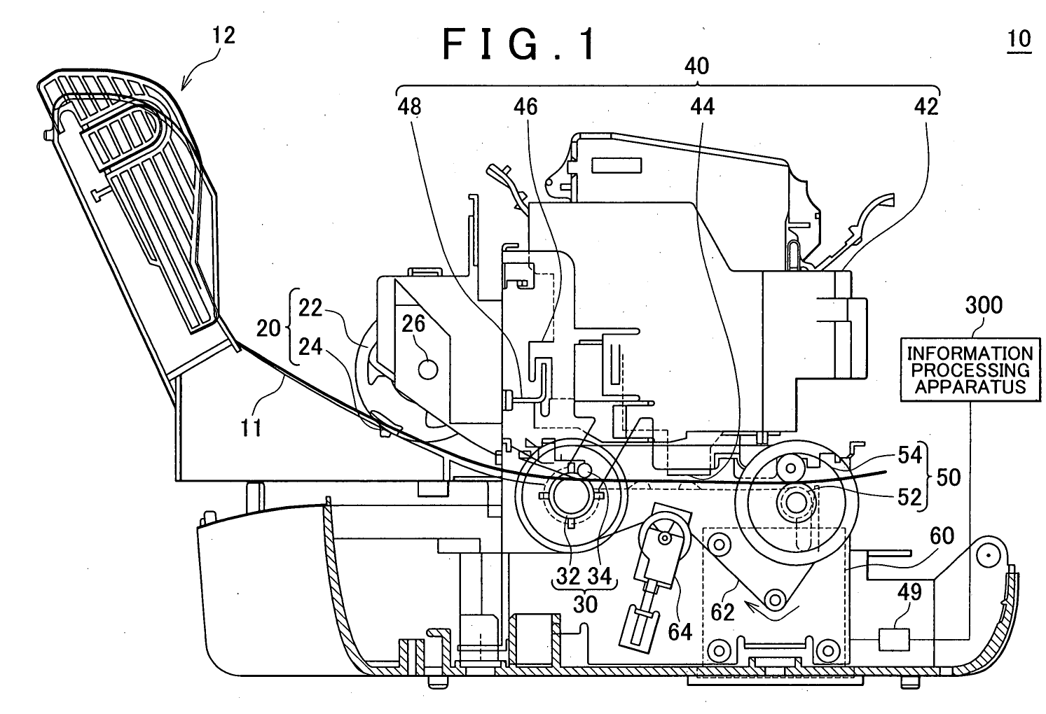

FIG. 1 is a side view schematically showing the inner configuration of an inkjet type recording apparatus.

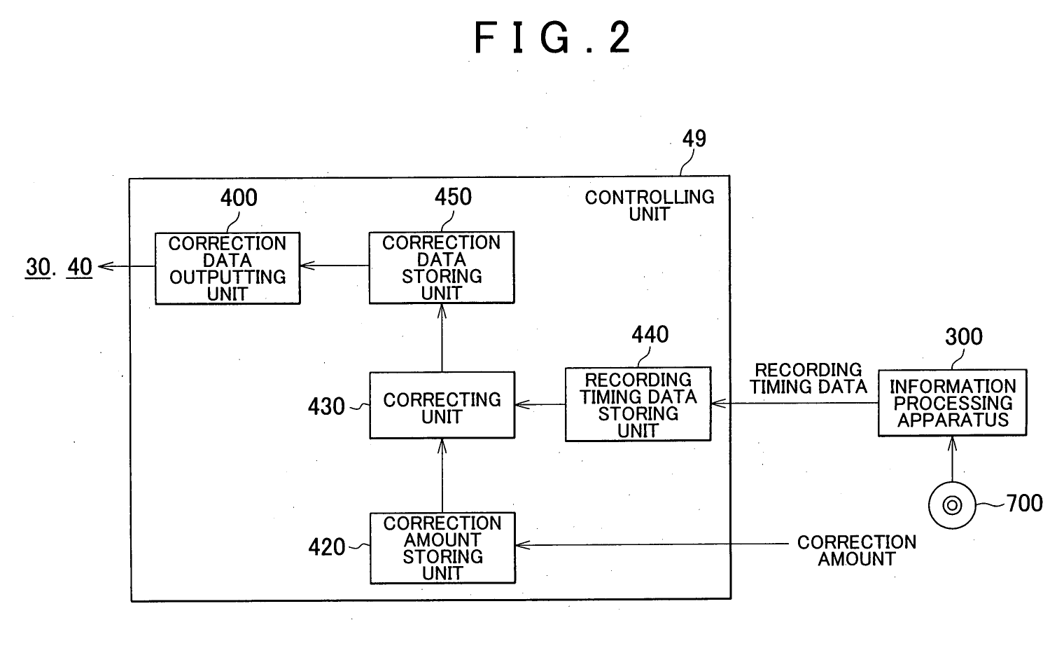

FIG. 2 shows an example of functional blocks of a controlling unit.

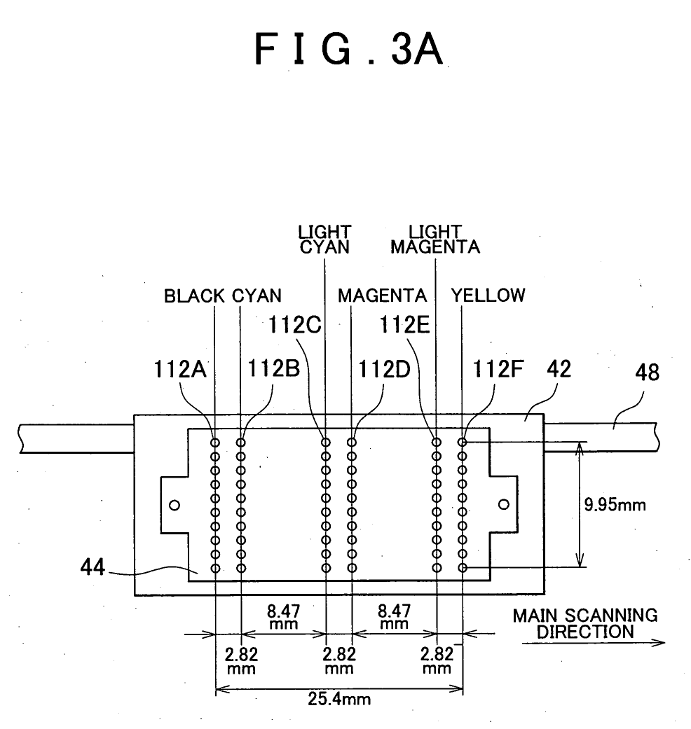

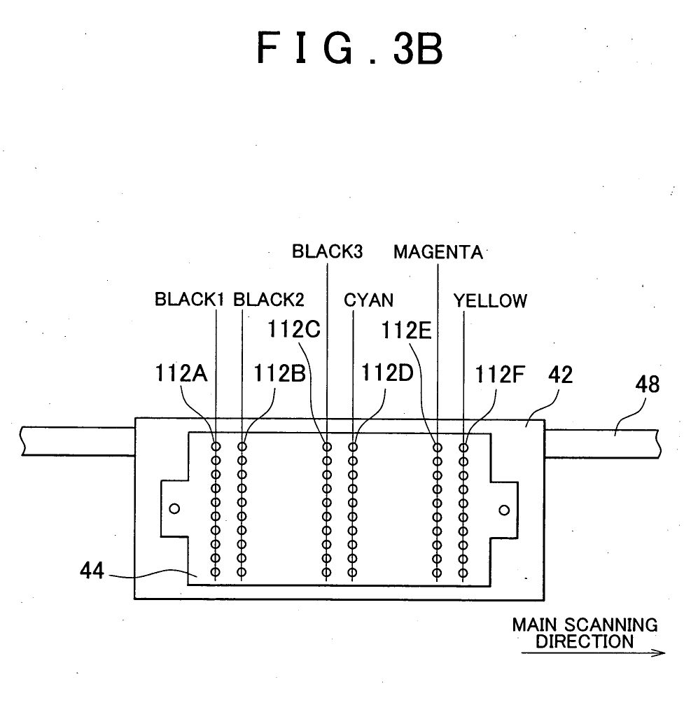

FIGS. 3A and 3B are bottom views of a carriage on which a recording head is provided.

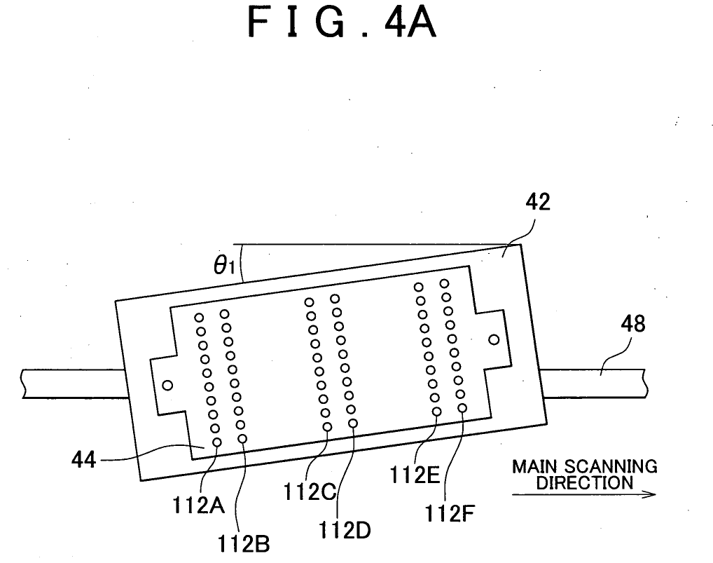

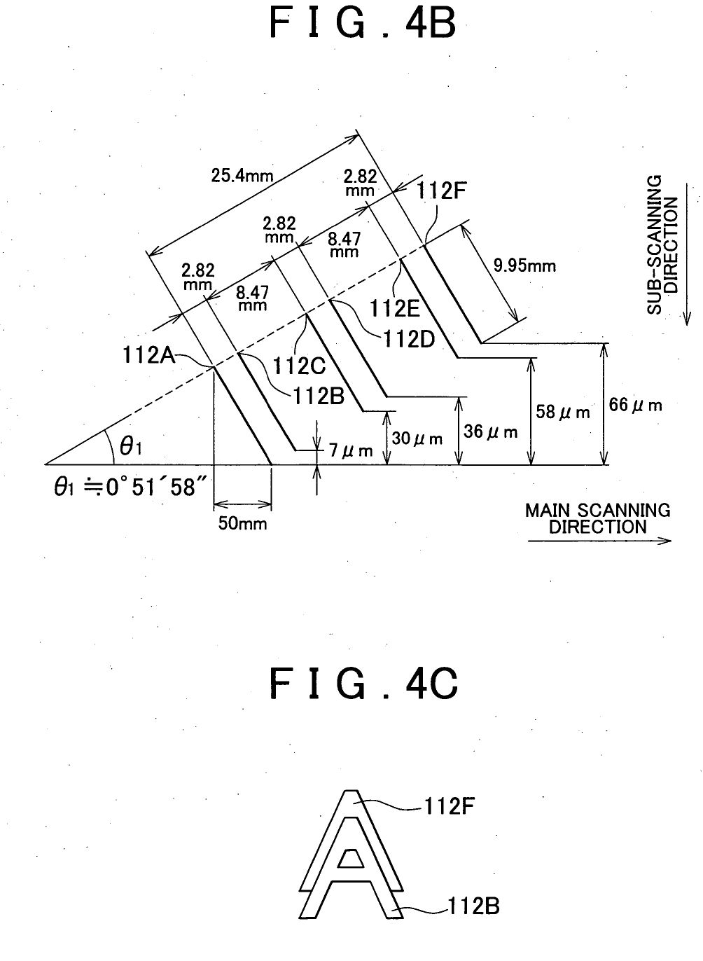

FIG. 4A shows an example of a position deviation of nozzle arrays in a sub-scanning direction, FIG. 4B shows the amount of the position deviation above and FIG. 4C shows a recording result caused by ink dots performed by the nozzle arrays having the amount of the position deviation.

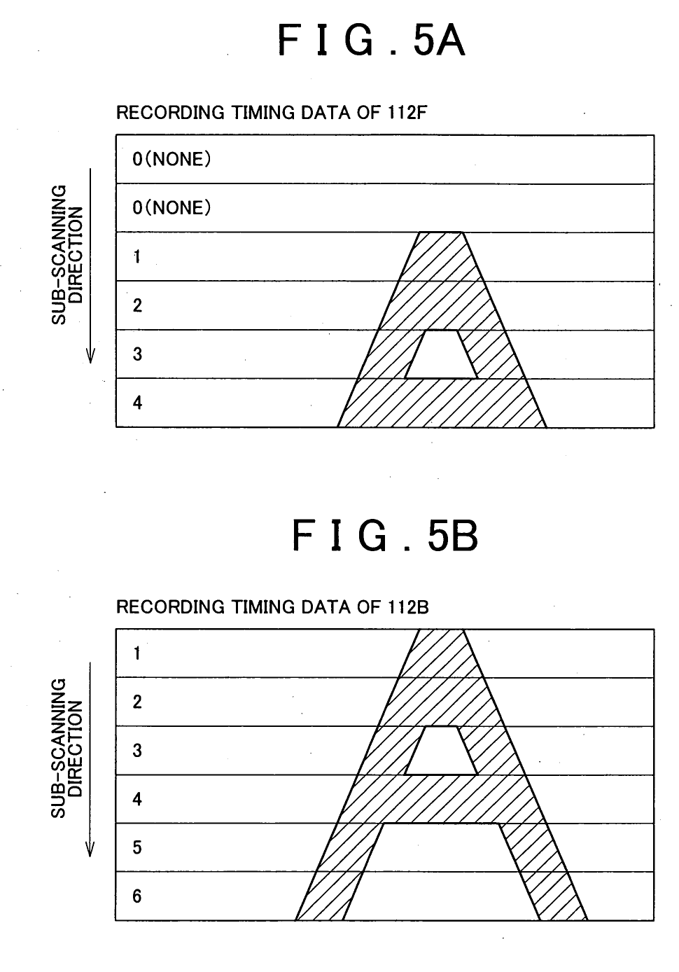

FIGS. 5A and 5B show a correction method of recording timing data.

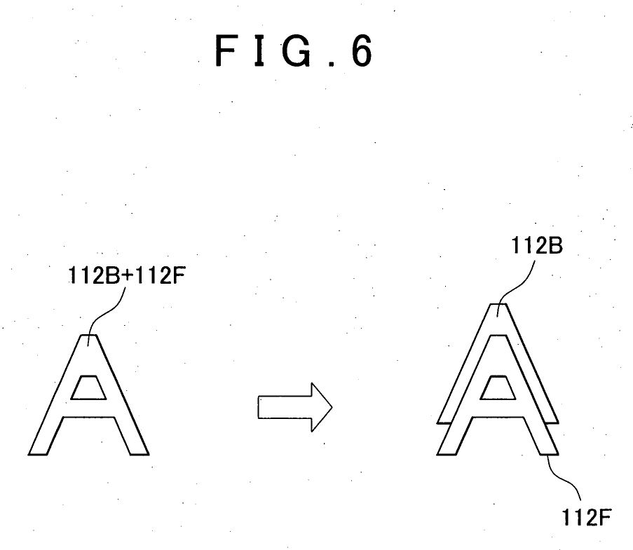

FIG. 6 shows recording results of combining each color before and after a correction.

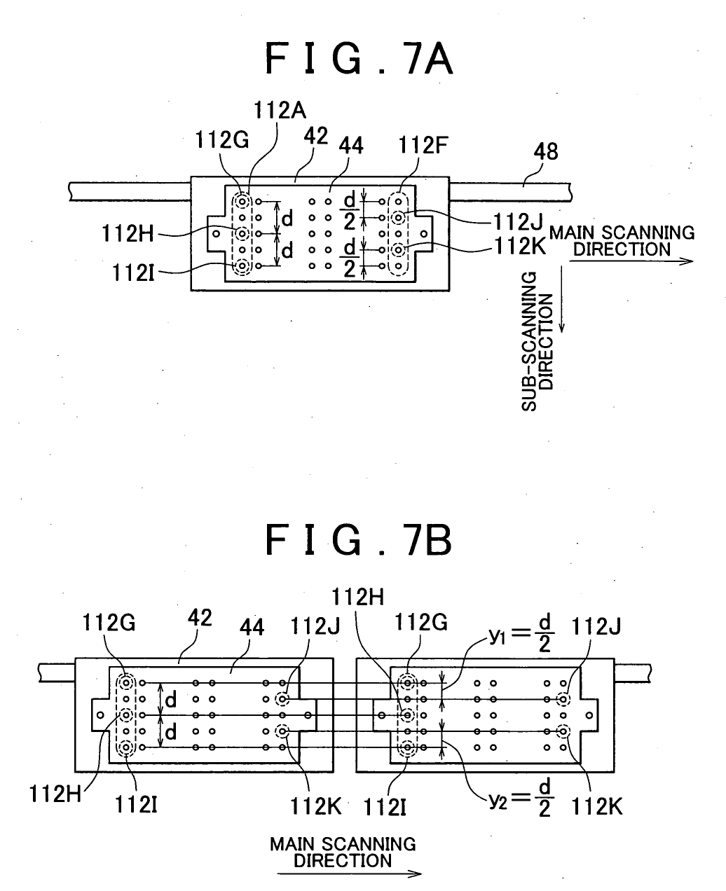

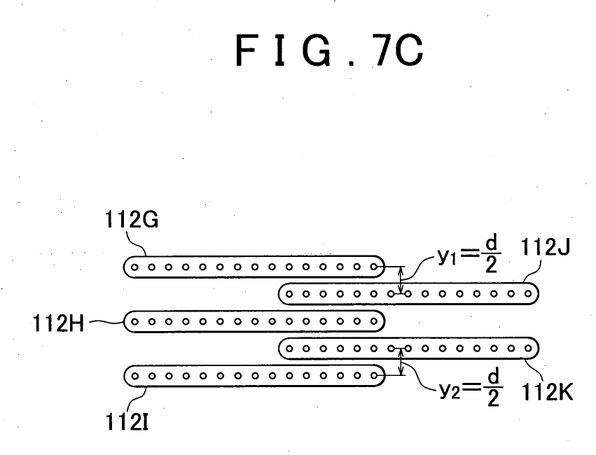

FIG. 7A shows an example of a position deviation of nozzle arrays in a sub-scanning direction, FIG. 7B shows the amount of the position deviation above and FIG. 7C shows a method for measuring the amount of the position deviation in a sub-scanning direction caused by ink dots performed by the nozzle arrays having the amount of the position deviation.

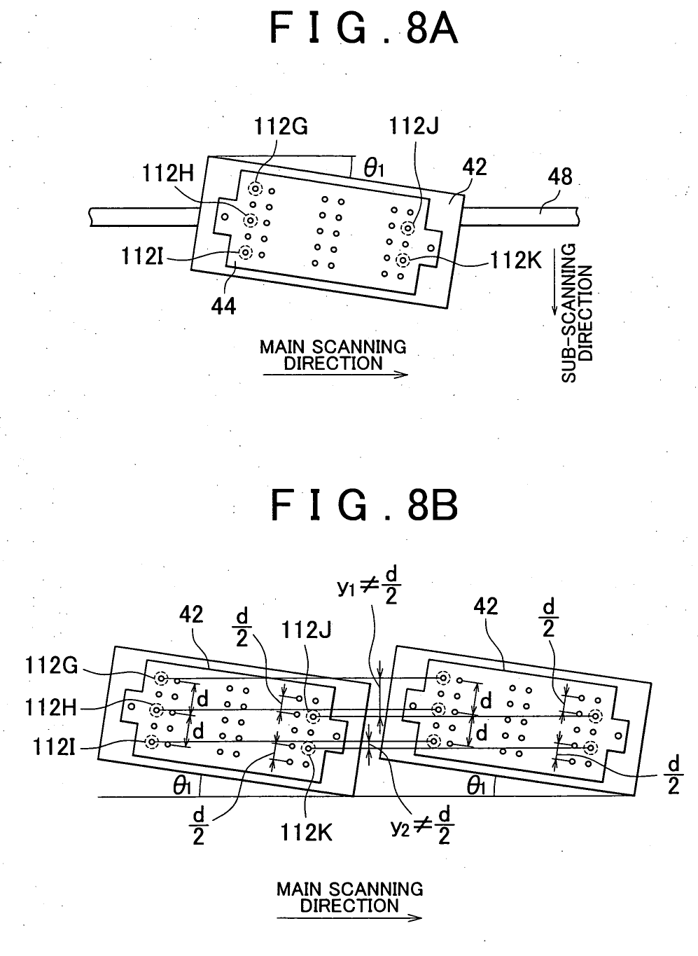

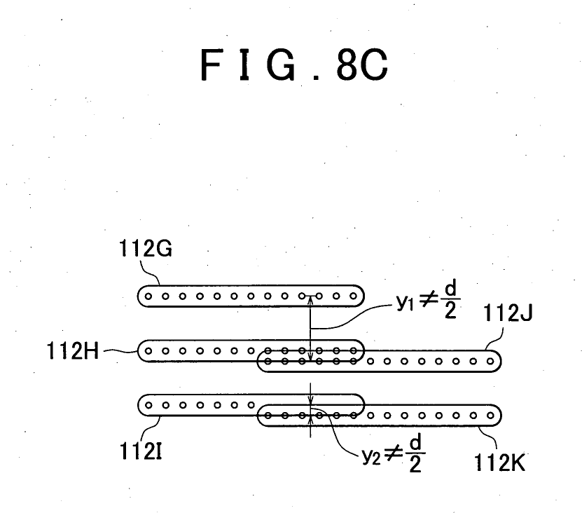

FIG. 8A shows another example of a position deviation of nozzle arrays in a sub-scanning direction, FIG. 8B shows the amount of the position deviation above and FIG. 8C shows a method for measuring the amount of the position deviation in a sub-scanning direction caused by ink dots performed by the nozzle arrays having the amount of the position deviation.

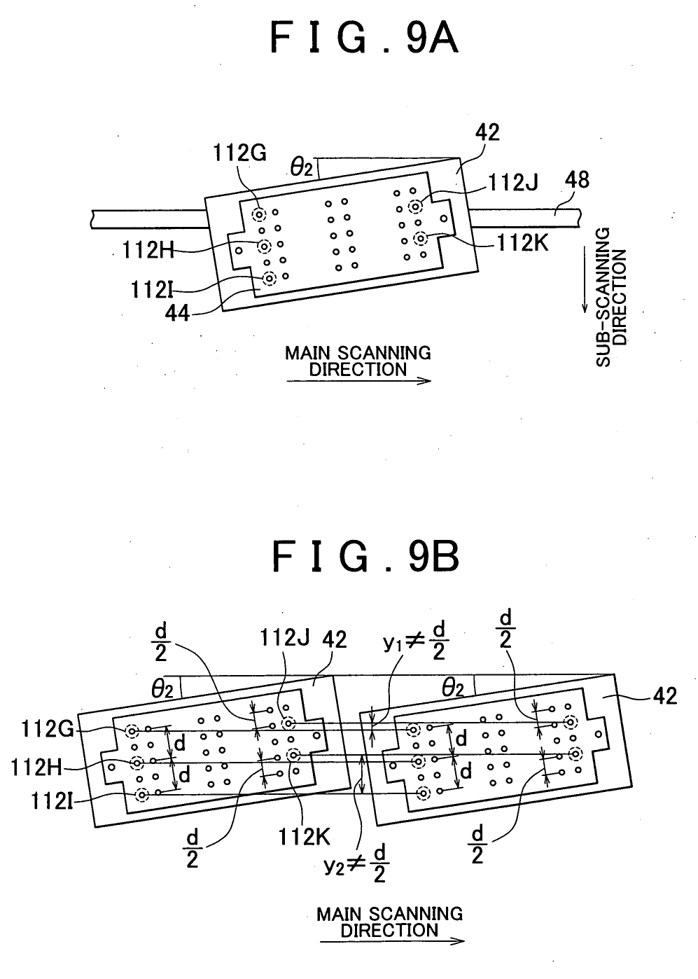

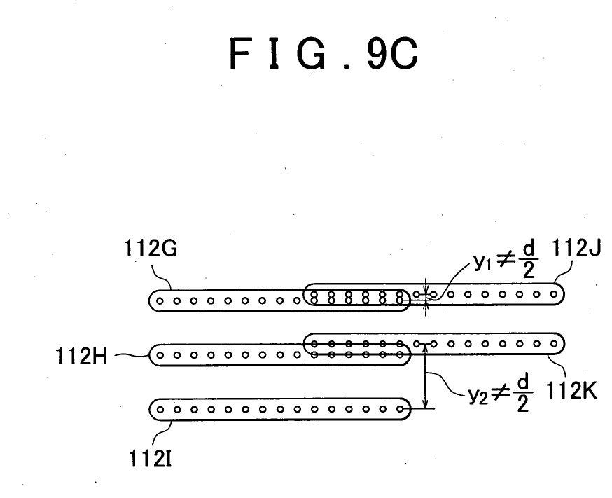

FIG. 9A shows further another example of a position deviation of nozzle arrays in a sub-scanning direction, FIG. 9B shows the amount of the position deviation above and FIG. 9C shows a method for measuring the amount of the position deviation in a sub-scanning direction caused by ink dots performed by the nozzle arrays having the amount of the position deviation.

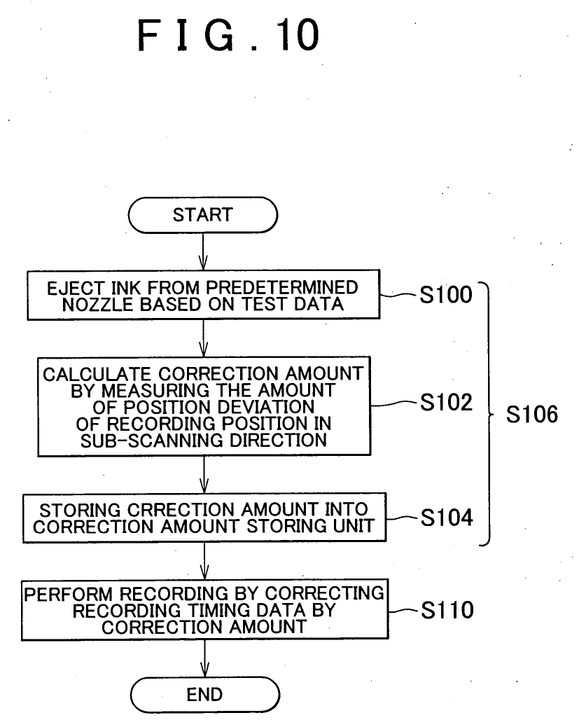

FIG. 10 shows an example of a flowchart illustrating processes of a recording position correction method according to the present embodiment.

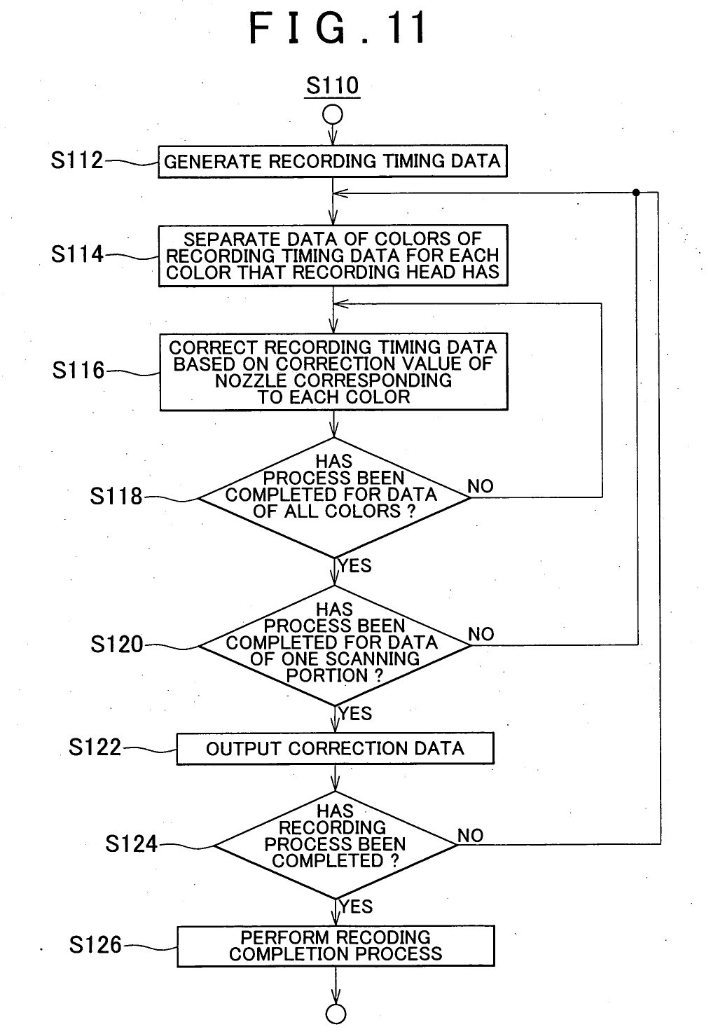

FIG. 11 shows processes of a correction step S110 in detail.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

It is an object of a recording position correction method, an inkjet type recording apparatus and a computer program therefor according to the present embodiment to make up for the recording error that occurs due to the imprecise mounting or looseness of the recording head in order to perform recording as closely as in a way that a user desires.

FIG. 1 is a side view schematically showing the inner configuration of an inkjet type recording apparatus. Here, the inkjet type recording apparatus 10 is an example of a liquid ejecting apparatus. In addition, a recording head of the inkjet type recording apparatus 10 is an example of a liquid ejecting head of the liquid ejecting apparatus. Nozzles arranged on the recording head are an example of ejecting openings of the liquid ejecting head. In addition, a medium to be recorded 11 is an example of a target.

However, the inkjet type recording apparatus is not limited to this embodiment. As another example of the liquid ejecting apparatus, there is a color filter manufacturing apparatus for manufacturing a color filter of a liquid crystal display. In this case, a color material ejecting head of the color filter manufacturing apparatus is an example of the liquid ejecting head. Further another example of the liquid ejecting apparatus is an electrode forming apparatus for forming electrodes such as an organic EL display, a FED (Field Emission Display) or the like. In this case, an electrode material (conduction paste) ejecting head of the electrode forming apparatus is an example of the liquid ejecting head. Further another example is a biochip manufacturing apparatus for manufacturing biochips. In this case, a bio organism ejecting head of the biochip manufacturing apparatus and a sample ejecting head as a minute pipette are examples of the liquid ejecting head. The liquid ejecting apparatus of the present invention includes other liquid ejecting apparatuses used for industrial purposes.

The inkjet type recording apparatus 10, as shown in FIG. 1, includes a stack unit 12 for holding a stack of medium to be recorded 11, a feeding unit 20 for taking one medium to be recorded 11 out of the stack unit 12 and feeding it in order to perform recording, a transferring unit 30 for transmitting force in a feeding direction to the medium to be recorded 11 fed by the feeding unit 20, a recording unit 40 for performing recording on the medium to be recorded 11 and a discharging unit 50 for transmitting power to the medium 11 on which recording is finished in a discharge direction, along the feeding order.

The feeding unit 20 includes a paper feed roller 22 and a separation pad 24 which are rotated by a motor, not shown, together with a driving shaft. The paper feed roller 22 is substantially the shape of a fan, and the driving shaft 26 is provided at the center of an arc that is a part of the fan. As the paper feed roller 22 is rotated, the paper feed roller 22 repeats contact and separation states with and from the separation pad 24. In the contact state, the paper feed roller 22 and the separation pad 24 separate the medium to be recorded 11 piled on the stack unit 12 one by one by holding a medium to be recorded 11 placed on the top of the pile between the paper feed roller 22 and the separation pad 24, and feed it to the transferring unit 30. During this feeding process, the paper feed roller 22 and a hopper that is a part of the stack unit 12 are separated from each other in order to put the medium 11 on which recording has not been performed back to the stack unit 12 for arrangement.

The transferring unit 30 includes a transferring roller 32 that is rotated by a motor 60 and a transfer driven roller 34 that is rotated accompanying the transferring roller 32, so that it transfers the medium to be recorded 11 fed by the feeding unit 20 toward a lower part of the recording unit 40 by holding the medium to be recorded 11 at a contact point between the transferring roller 32 and the transfer driven roller 34.

The recording unit 40 includes a carriage 42 in which an ink cartridge is mounted, a recording head 44 provided on a surface, which faces the medium to be recorded 11, of the carriage 42 for ejecting ink, an engaging part 46 provided on the carriage 42, a guide 48 engaged with the engaging part 46 for supporting the carriage 42 to slide freely along at least either a forward or backward path in a main scanning direction substantially perpendicular to the feeding direction and a controlling unit 49 for controlling recording. Here, a sub-scanning direction is defined as the feeding direction of the medium to be recorded 11. The controlling unit 49 controls recording by controlling the recording unit 40 and the transferring unit 30 in accordance with recording timing data received from an information processing apparatus 300 such as a computer. Further, on the recording head 44, a plurality of nozzle arrays in each of which a plurality of nozzles are arranged along a direction in which the medium to be recorded 11 is transferred (the sub-scanning direction) are arranged along the main scanning direction of the carriage 42.

The discharging unit 50 includes a discharging roller 52 that is rotated by the motor 60 and a discharge driven roller 54 rotated accompanying the discharging roller 52, so that it discharges the medium 11 after recording by holding the medium 11 at a contact point between the discharging roller 52 and the discharge driven roller 54.

Further, the transfer driven roller 34 is provided above the transferring roller 32 and biased towards the recording head 44 compared with the transferring roller 32, and the discharge driven roller 54 is provided above the discharging roller 52 and biased towards the recording head 44 compared with the discharging roller 52. Therefore, the medium to be recorded 11 is bent downwards at a position facing the recording unit 40.

In the configuration described above, the ink-jet type recording apparatus 10 ejects ink while reciprocating the recording head 44 along the guide 48. The inkjet type recording apparatus 10 performs recording for all of the medium to be recorded 11 by feeding them at each time the recording head 44 performs the scanning operation. Further, the recording head 44 may perform recording for both forward and backward paths or may perform for either of them.

Further, the transferring unit 30 and the discharging unit 50 are supplied with the power transmitted from the motor 60 via a belt 62. The belt 62 is applied with tension by a tensioner 64. The motor 60, the tensioner 64, the transferring unit 30 and the discharging unit 50 are arranged in line along a direction in which the belt 62 flows.

FIG. 2 shows an example of functional blocks of a controlling unit 49. The controlling unit 49 includes a recording timing data storing unit 440, a correcting unit 430, a correction amount storing unit 420, a correction data storing unit 450 and a correction data outputting unit 400.

The recording timing data storing unit 440 acquires and stores recording position data to be recorded on the medium 11 from the information processing apparatus 300. In the present embodiment, the recording timing data storing unit 440 acquires and stores recording timing data that indicates at which time of scanning the ink should be ejected from the nozzle as the recording position data. The correction amount storing unit 420 stores a correction amount for correcting the recording timing data to correct the recording positions of ink dots recorded, if there is a position deviation in the sub-scanning direction of a plurality of nozzle arrays arranged on the recording head 44. The correction amount of the recording timing data is calculated based on the position deviation of a plurality of nozzle arrays in the sub-scanning direction.

The correcting unit 430 acquires the recording timing data from the recording timing data storing unit 440 and acquires the correction amount of the recording timing data from the correction amount storing unit 420. Further, the correcting unit 430 corrects the recording timing data by shifting the recording positions of the ink dots to be recorded in advance in regard to each nozzle of a plurality of nozzle arrays based on the correction amount acquired from the correction amount storing unit 420 and stores it into the correction data storing unit 450. The correction data outputting unit 400 acquires the recording timing data corrected from the correction data storing unit 450, and outputs it to the transferring unit 30 and the recording unit 40. Therefore, the transferring unit 30 and the recording unit 40 records the ink dots on the medium to be recorded 11 based on the recording timing data corrected.

In addition, as further another modification, a recording medium 700, in which a computer program for operating the recording timing data storing unit 440, the correcting unit 430, the correction amount storing unit 420, the correction data storing unit 450 and the correction data outputting unit 400 is stored, may be installed in the information processing apparatus 300 and the information processing apparatus 300 may correct the recording timing data based on the computer program stored in the recording medium 700. The recording medium 700 may be distributed as utility software. In addition, as another modification, the information processing apparatus 300 may acquire the computer program for operating those units via a communications line.

In this way, the controlling unit 49 corrects the recording timing data by shifting the recording positions of the ink dots to be recorded on the medium 11 in advance based on the amount of the position deviation in the sub-scanning direction of a plurality of nozzles. Therefore, in comparison to a case that correction is performed while the carriage 42 is fitted with the guide 48, in the present embodiment, it is possible to easily correct the amount of the position deviation of a plurality of nozzles in the sub-scanning direction. Further, according to the present embodiment, it is not necessary that correction is performed while the carriage 42 is fitted with the guide 48, so that the number of parts of the inkjet type recording apparatus 10 can be reduced.

FIGS. 3A and 3B are bottom views of the carriage 42 on which the recording head 44 is provided. FIG. 3A shows a bottom view of the carriage 42 including a recording head 44 of six colors and six rows, and FIG. 3B shows a bottom view of the carriage 42 including a recording head 44 of four colors and six rows. As shown in FIGS. 3A and 3B, the recording head 44 includes a plurality of nozzle arrays, in each of which a plurality of nozzles for ejecting ink of one color are arranged in the sub-scanning direction, along the main scanning direction for each of a plurality of colors.

For example, the recording head 44 in FIG. 3A includes nozzle arrays 112A to 112F respectively corresponding to six colors, i.e. BLACK, CYAN, LIGHT CYAN, MAGENTA, LIGHT MAGENTA and YELLOW. In addition, the recording head 44 in FIG. 3B includes nozzle arrays 112A to 112F corresponding to four colors, i.e. BLACK, CYAN, MAGENTA and YELLOW. In addition, each of the nozzle arrays 112A to 112F includes a plurality of nozzles (ten nozzles in FIGS. 3A and 3B) arranged along the sub-scanning direction. The intervals of each of the nozzle arrays 112A to 112F in FIG. 3A are, e.g. 2.82 mm, 8.47 mm, 2.82 mm, 8.47 mm and 2.82 mm from the left. In addition, the height of each row is 9.95 mm. The arrangement intervals of the nozzle arrays 112A to 112F and the height of each row are not limited to the examples shown in FIG. 3A, and may be other arrangement interval.

FIG. 4 shows an example of the deviation of a plurality of nozzle arrays 112 in a sub-scanning direction. FIG. 4A shows the bottom of the carriage 42. As shown in FIG. 4A, the carriage 42 might have a tilt of θ1 against the longitudinal direction of the guide 48 due to a bad condition, looseness or the like of mounting onto the guide 48. Because of the tilt, each of the nozzle arrays 112A to 112F deviates in the sub-scanning direction, so that the recording positions of the ink dots recorded on the medium to be recorded 11 deviate.

FIG. 4B shows an example of the position deviation in the sub-scanning direction of a plurality of nozzle arrays 112A to 112F having the recording head 44 shown in FIG. 4A. In FIG. 4B each of the nozzle arrays 112A to 112F is shown as solid lines. The carriage 42 shown in FIG. 4B is fitted with the guide 48 to have an angle or tilt of approximately 0 (zero) degree, 51 minutes and 58 seconds against the longitudinal direction of the guide 48. In case of the recording head 44 shown in FIG. 4B, the distance between the nozzle array 112A, the most left one, and the nozzle array 112F, the most right one, is 25.4 mm. The distance between the lowest nozzles of the nozzle array 112F, the most right one, and the nozzle array 112A, the most left one, in the sub-scanning direction is approximately 66 μm.

FIG. 4C shows a record result “A” caused by the ink dots recorded on the medium to be recorded 11 after scanning of the carriage 42 shown in FIGS. 4A and 4B. As shown in FIG. 4B, each nozzle of the nozzle array 112F is positioned to be higher than each nozzle of the nozzle array 112B in a direction opposite to the sub-scanning direction by 59 μm. Therefore, as shown in FIG. 4C, the record result “A” formed of the ink dots recorded by ejection from the nozzle array 112F is positioned to be higher than the record result “A” formed of the ink dots recorded by ejection from the nozzle array 112B. Therefore, the record result “A”, which is supposed to be recorded as one letter, is recorded as two letters in which the position deviates in the sub-scanning direction. Particularly, as shown in FIGS. 3A and 3B, since the nozzle arrays 112B and 112F eject ink of colors different from each other, i.e. cyan and yellow or black and yellow, it is obvious that the recording position recorded on the medium to be recorded deviates. Since the resolution of the naked eye is approximately 20 μm, the deviation of the recording position shown in FIG. C can be recognized to the naked eye.

FIG. 5A and 5B show a correction method of recording timing data according to the present embodiment. In the present embodiment, each of the recording positions of the ink dots recorded with various colors is shifted in advance, and the recording timing data is shifted and corrected. As shown in FIG. 4C, the record result “A” formed of the ink dots recorded by ejection from the nozzle array 112F is positioned to be higher than the record result “A” formed of the ink dots recorded by ejection from the nozzle array 112B. Accordingly, as shown in FIG. 5A, the recording position of “A” to be formed of the ink dots to be recorded by ejection from the nozzle array 112F is corrected by shifting the position to be low as much as 2 dots in the sub-scanning direction in advance. In addition, as shown in FIG. 5B, “A” to be formed of the ink dots to be recorded by ejection from the nozzle array 112B is not corrected. In other words, the recording timing data corresponding to each of the nozzle arrays 112A to 112F is corrected in a direction opposite to the position deviation of the nozzle arrays 112A to 112F as much as each of the position deviations of the nozzle arrays 112A to 112F in the sub-scanning direction caused by the tilt of the carriage 42.

The amount of the position deviation of each of the nozzle arrays 112A to 112F in the sub-scanning direction shown in FIG. 4B is measured in the factory at the time of the shipment of the inkjet type recording apparatus. The correction amount of the recording timing data for correcting the recording position is calculated based on the amount of the measured deviation, and stored into the correction amount storing unit 420 in advance. The recording position based on the correction amount of the recording timing data can be shifted per one dot. The value of one dot is 1/720 inch, 1/1440 inch or the like. However, the value of one dot may be adjusted according to the resolution of the inkjet type recording apparatus. Since 1/720 inch is approximately 35 μm and the resolution of the naked eye is about 20 μm to 30 μm, the recording position can be corrected to the extent that it cannot be recognized to the naked eye by shifting the recording position by 1/720 inch. Further, since 1/1440 inch is approximately 17.5 μm, the recording position can be corrected to even further extent that it cannot be recognized to the naked eye compared with 1/720 inch.

FIG. 6 shows recording results of combining each color before and after a correction. In case of using the recording head 44 of 6 colors and 6 rows shown in FIG. 3A, if the recording head 44 is not tilted to the guide 48, in the recording result of combining each color before the correction shown as the left one in FIG. 6, “A” recorded by the ink ejected from the nozzle array 112B and “A” recorded by the ink ejected from the nozzle array 112F are positioned uniformly in the sub-scanning direction. On the other hand, in the recording result of combining each color after the correction shown as the right one in FIG. 6, “A” recorded by the ink ejected from the nozzle array 112F is corrected to be shifted in the sub-scanning direction as much as 2 dots downwardly than “A” recorded by the ink ejected from the nozzle array 112B as shown in FIGS. 5A and 5B. Therefore, if recording is performed on the medium to be recorded 11 in the corrected state above by using the carriage 42 normally fitted with the guide 48, two letters of “A” will be recorded while one is shifted against the other in the sub-scanning direction.

However, if recording is performed on the medium to be recorded 11 in the corrected state above by using the carriage 42 fitted with the guide 48 while it is tilted as shown in FIG. 4A and 4B, since the recording position is shifted in advance as much as the deviation amount of the nozzle 112 in the sub-scanning direction, in contrast that two letters are recorded on the medium to be recorded 11 while one is shifted against the other in the sub-scanning direction before the correction, one letter of “A”, which is supposed to be shown on the medium to be recorded 11, is recorded. In the examples in FIG. 4 to FIG. 6, since “A” that is formed of the ink dots to be recorded by ejection from the nozzle array 112F is corrected in advance to be shifted in the sub-scanning direction by 2 dots downwardly than “A” that is formed of the ink dots to be recorded by ejection from the nozzle array 112F, “A” formed of the ink dots ejected and recorded from the nozzle array 112F and “A” formed of the ink dots ejected and recorded from the nozzle array 112F are recorded to substantially match with each other.

In this way, the inkjet type recording apparatus according to the present embodiment shifts the recording positions of ink dots to be recorded on the medium 11 based on the amount of the position deviation of a plurality of nozzle arrays 112A to 112F in the sub-scanning direction. Therefore, even if the carriage 42 is fitted with the guide 48 while it is tilted, recording can be performed on the medium to be recorded 11 in the shape supposed to be recorded without adjusting the carriage 42 mechanically.

FIG. 7 to 9 show an example of a method for measure the amount of the position deviation of a plurality of nozzle arrays 112A to 112F in the sub-scanning direction according to the present embodiment. FIG. 7A shows a state that the carriage 42 is fitted with the guide 48 normally. In the present embodiment, to measure the amount of the position deviation of the nozzle arrays 112A to 112F in the sub-scanning direction, the ink dots are recorded on the medium to be recorded 11 by ejecting ink from at least one nozzle of each of at least two nozzle arrays most distanced from each other in the main scanning direction among a plurality of nozzle arrays 112A to 112F. For example, at least one of a pair of nozzles, i.e. a first nozzle 112G from the top of the most left nozzle array 112A and a second nozzle 112J from the top of the most right nozzle array 112F or a pair of nozzles, i.e. a lowest nozzle 112I of the most left nozzle array 112A and a fourth nozzle 112K of the most right nozzle array 112F is used. The reason why a pair of nozzles most distanced from each other in the main scanning direction are used is because the amount of deviation of the nozzle 112 in the sub-scanning direction is largest as shown in FIG. 4B. Therefore, the amount of deviation can be exactly measured.

The amounts of deviation of other nozzle arrays except the two nozzle arrays distanced from each other in the main scanning direction can be obtained by dividing the amount of deviation of the two nozzle arrays distanced from each other in the main scanning direction in proportion to the arrangement interval of each nozzle array in regard to the recording head 44 shown in FIG. 3A.

In case of FIG. 7A, the first, third and fifth nozzles 112G, 112H and 112I from the top of the most left nozzle array 112A surrounded by a broken line and the second and fourth nozzles 112J and 112K from the top of the most right nozzle array 112F surrounded by a broken line are used. Since the distance to be measured becomes large by making the numbers 1, 3 and 5 of the used nozzles of the most left nozzle array 112A and the numbers 2 and 4 of the used nozzles of the most right nozzle array 112F different, the amount of deviation of the nozzle 112 in the sub-scanning direction can be easily measured.

In addition, as shown in FIG. 7A, each of the nozzles 112G to 112K is arranged on the recording head 44 in order that if the interval between the nozzles 112G and 112H in the sub-scanning direction is defined as d, the interval between the nozzles 112G and 112J in the sub-scanning direction becomes d/2, the interval between the nozzles 112H and 112I in the sub-scanning direction becomes d and the interval between the nozzles 1121 and 112K in the sub-scanning direction becomes d/2.

FIG. 7B shows the loci drawn by each of the nozzles 112G to 112K when the carriage 42 moves to the right, i.e. through the forward path in the main scanning direction along the guide 48, and FIG. 7C shows ink dots ejected and recorded on the medium to be recorded 11 when the carriage 42 performs a scanning operation as shown in FIG. 7B while ejecting ink from the nozzles 112G to 112K. Since the carriage 42 is fitted with the guide 48 without a tilt, as shown in FIG. 7B, the interval y1 between the loci drawn by the nozzles 112G and 112J in the sub-scanning direction is d/2 and the interval y2 between the loci drawn by the nozzles 1121 and 112K in the sub-scanning direction is d/2.

Therefore, as shown in FIG. 7C, the interval y1 in the sub-scanning direction between a line formed by the ink dots ejected from the nozzle 112G and recorded on the medium to be recorded 11 and a line formed by the ink dots ejected from the nozzle 112J and recorded on the medium to be recorded 11 is d/2, and the interval y2 in the sub-scanning direction between a line formed by the ink dots ejected from the nozzle 112I and recorded on the medium to be recorded 11 and a line formed by the ink dots ejected from the nozzle 112K and recorded on the medium to be recorded 11 is d/2. In other words, if the carriage 42 is fitted with the guide 48 normally, the intervals y1 and y2 in the sub-scanning direction between lines formed by the ink dots recorded on the medium to be recorded 11 from each of the nozzles 112G to 112K become d/2. Accordingly, if the values resulting from measuring the intervals y1 and y2 are not equal to d/2, it can be judges that the carriage 42 is fitted with the guide 48 while it is tilted.

FIG. 8A shows a carriage 42 fitted with the guide 48 while the left end of the carriage 42 is tilted in the sub-scanning direction. In an example shown in FIG. 8A, the carriage 42 has a tilt of θ1 against the longitudinal direction of the guide 48. FIG. 8B shows the loci drawn by each of the nozzles 112G to 112K when the carriage 42 shown in FIG. 8A moves to the right, i.e. through the forward path in the main scanning direction along the guide 48, and FIG. 8C shows ink dots ejected and recorded on the medium to be recorded 11 when the carriage 42 performs a scanning operation as shown in FIG. 8B while ejecting ink from the nozzles 112G to 112K. As shown in FIG. 8B, the interval y1 between the loci drawn by the nozzles 112G and 112J in the sub-scanning direction is larger than d/2 and the interval y2 between the loci drawn by the nozzles 112I and 112K in the sub-scanning direction is smaller than d/2.

Therefore, as shown in FIG. 8C, the interval y1 in the sub-scanning direction between a line formed by the ink dots ejected from the nozzle 112G and recorded on the medium to be recorded 11 and a line formed by the ink dots ejected from the nozzle 112J and recorded on the medium to be recorded 11 is larger than d/2. And, the interval y2 in the sub-scanning direction between a line formed by the ink dots ejected from the nozzle 112I and recorded on the medium to be recorded 11 and a line formed by the ink dots ejected from the nozzle 112K and recorded on the medium to be recorded 11 is smaller than d/2. In addition, since the amount of the position deviation of the nozzle array in the direction in which the carriage 42 is tilted to the guide 48 and in the sub-scanning direction can be obtained from the intervals y1 and y2, the correction amount of the recording timing in regard to each nozzle of a plurality of nozzle arrays can be calculated based on the obtained amount of the deviation.

FIG. 9A shows a carriage 42 fitted with the guide 48 while the right end of the carriage 42 is tilted in the sub-scanning direction. In an example shown in FIG. 9A, the carriage 42 has a tilt of θ2 against the longitudinal direction of the guide 48. FIG. 9B shows the loci drawn by each of the nozzles 112G to 112K when the carriage 42 shown in FIG. 9A moves to the right, i.e. through the forward path in the main scanning direction along the guide 48, and FIG. 9C shows ink dots ejected and recorded on the medium to be recorded 11 when the carriage 42 performs a scanning operation as shown in FIG. 9B while ejecting ink from the nozzles 112G to 112K. As shown in FIG. 9B, the interval y1 between the loci drawn by the nozzles 112G and 112J in the sub-scanning direction is smaller than d/2 and the interval y2 between the loci drawn by the nozzles 112I and 112K in the sub-scanning direction is larger than d/2.

Therefore, as shown in FIG. 9C, the interval y1 in the sub-scanning direction between a line formed by the ink dots ejected from the nozzle 112G and recorded on the medium to be recorded 11 and a line formed by the ink dots ejected from the nozzle 112J and recorded on the medium to be recorded 11 is smaller than d/2. And, the interval y2 in the sub-scanning direction between a line formed by the ink dots ejected from the nozzle 112I and recorded on the medium to be recorded 11 and a line formed by the ink dots ejected from the nozzle 112K and recorded on the medium to be recorded 11 is larger than d/2. Therefore, if the values resulting from measuring the intervals y1 and y2 are not equal to d/2, it can be judges that the carriage 42 is fitted with the guide 48 while it is tilted.

In addition, the interval y1 is larger than the interval y2 in case of FIG. 8, and the interval y1 is small than the interval y2 in case of FIG. 9. Therefore, if the directions in which the carriage 42 is tilted to the guide 48 are different as shown in FIGS. 8 and 9, the values of the intervals y1 and y2 are different. Accordingly, the direction in which the carriage 42 is tilted to the guide 48 can be known from the intervals y1 and y2. Further, since the amount of deviation of nozzles in the sub-scanning direction can be obtained from the intervals y1 and y2, the correction amount of the recording timing in regard to each nozzle of a plurality of nozzle arrays can be calculated based on the obtained amount of the deviation.

Moreover, the intervals y1 and y2 are changed corresponding to the tilt θ1 or θ2 of the carriage 42 to the guide 48. However, since the intervals y1 and y2 are not d/2 in case the carriage 42 is fitted with the guide 48 while it is tilted, it can be judged whether the carriage 42 is tilted to the guide 48 by measuring the intervals y1 and y2.

In addition, alternatively, the amount of the position deviation of nozzles in the sub-scanning direction may be measured based on recoding results on the medium to be recorded 11 performed by the ink ejected from the nozzles of other nozzle arrays except the nozzles 112G and 112J or 112I and 112K of the two nozzle arrays most distanced from each other. For example, the amount of the position deviation of nozzles in the sub-scanning direction may be measured based on recoding results on the medium to be recorded 11 performed by the ink dots ejected and recorded from the nozzles of one of the nozzle arrays 112B to 112E existing between the two nozzle arrays most distanced from each other.

In calculating the correction amount of the recording timing by obtaining the amount of the position deviation in the sub-scanning direction of the nozzle arrays 112B to 112E existing between the two nozzle arrays 112A and 112F by dividing the amount of the position deviation in the sub-scanning direction of the two nozzle arrays 112A and 112F most distanced from each other in the main scanning direction in proportion to the arrangement relation of each nozzle array in regard to the recording head 44, it might be difficult to judge the correction amount of the recording timing of the nozzle arrays 112B to 112E even by the amount of the position deviation in the sub-scanning direction of the two nozzle arrays 112A and 112F.

For example, if the amount of deviation of the two nozzle arrays 112A and 112F in the sub-scanning direction is 2.6 dots, it is determined as a shift of 3 dots. At this time, if the value obtained by dividing in proportion to the deviation amount of the nozzle array 112D is 1.5, correction might not be performed to the extent that the position deviation of the ink dots recorded is not recognized to the naked eye by shifting the nozzle array 112D by 2 dots. Accordingly, by further measuring the amount of the position deviation in the sub-scanning direction of the nozzle arrays 112B to 112E between the two nozzle arrays 112A and 112F as well, the correction amount of the recording timing corresponding to the nozzle arrays 112B to 112E can be calculated accurately. In the example above, if the amount of deviation in the sub-scanning direction of the two nozzle arrays 112A and 112F most distanced from each other is 2.6 dots, by measuring the amount of the position deviation of the nozzle array 112D, the recording position of the ink dots the nozzle array 112D is shifted by 1 dot, so that correction is performed to the extent that the position deviation of the ink dots recorded by the nozzle array 112D is not recognized to the naked eye.

In addition, if the carriage 42 is fitted with the guide 48 loosely, the carriage 42 rattles during moving. Therefore, the tilt of the carriage 42 to the guide 48 is changed both when the carriage 42 moves to the right, i.e. along the forward path in the main scanning direction and when the carriage 42 moves to the left, i.e. along the backward path in the main scanning direction. For example, when the carriage 42 moves along the forward path in the main scanning direction, the right end of the carriage 42 is tilted in the sub-scanning direction as shown in FIG. 8, and when the carriage 42 moves along the backward path in the main scanning direction, the left end of the carriage 42 is tilted in the sub-scanning direction as shown in FIG. 9. If the ink is ejected from the recording head 44 while the carriage 42 with looseness performs scanning operations in both directions along the forward and backward paths in the main scanning direction, the deviation of the recording position might be considerable.

Accordingly, the recording position may be corrected by obtaining an intermediate value between the amount of the position deviation of the recording position in the sub-scanning direction in case the recording head 44 performs scanning along the forward path in the main scanning direction and the amount of the position deviation of the recording position in the sub-scanning direction in case the recording head 44 performs scanning along the backward path in the main scanning direction and shifting the recording timing in advance based on the intermediate value. Therefore, it is possible to correct the position deviation of the recording position even when recording is performed in both directions, i.e. the forward and backward paths in the main scanning direction.

In addition, alternatively, the amount of the position deviation of the recording position in the sub-scanning direction in case the recording head 44 performs scanning along the forward path in the main scanning direction and the amount of the position deviation of the recording position in the sub-scanning direction in case the recording head 44 performs scanning along the backward path in the main scanning direction may be measured separately, so that the recording position in regard to the forward path in the main scanning direction can be shifted in advance based on the amount of the position deviation of the recording position in the sub-scanning direction in case the recording head 44 performs scanning along the forward path in the main scanning direction, while the recording position in regard to the backward path in the main scanning direction can be shifted in advance based on the amount of the position deviation of the recording position in the sub-scanning direction in case the recording head 44 performs scanning along the backward path in the main scanning direction. In this case, it is possible to correct the position deviation of the recording position of the ink dots recorded in each direction of the forward and backward paths in the main scanning direction.

In addition, alternatively, the ink may be ejected from nozzles of two nozzle arrays ejecting two colors respectively as priority is given to a color whose density is highest among a plurality of nozzle arrays, so that the recording position on the medium to be recorded in regard to each of the plurality of nozzles can be shifted in advance based on the amount of the position deviation of the recording position of the ink dots ejected and recorded from the nozzles. For example, the nozzle array 112B ejecting cyan whose density is high or the nozzle array 112D ejecting magenta whose density is high and the nozzle 112G ejecting black may be used. By using ink whose density is high, the visibility of recording results on the medium to be recorded 11 is increased, and thus it is possible to measure the amount of the position deviation of the recording position of the ink dots easily.

In this way, in the present embodiment, the ink dots are recorded on the medium to be recorded 11 by ejecting ink from a plurality of nozzle arrays 112A to 112F in order that the colors of ink are different respectively, and the amount of the position deviation of the recording position in the sub-scanning direction is measured for each color of the ink dots. Therefore, by using the measured amount of deviation of the nozzle 112, as shown in FIG. 5 and FIG. 6, the recording position of different color is shifted respectively in advance, so that correction can be performed. Therefore, even if the carriage 42 is fitted with the guide 48 while it is tilted, recording can be performed on the medium to be recorded 11 in the shape supposed to be recorded without adjusting the carriage 42 mechanically.

FIG. 10 is an example of the flowchart showing processes of a recording position correction method according to the present embodiment. The recording position correction method according to the present embodiment includes a setting step S106 of setting the correction amount of the recording timing to the inkjet type recording apparatus 10 in the factory or the like and a correction step S110 of correcting the recording timing data during the use of the inkjet type recording apparatus 10.

In the setting step S106, as described in FIGS. 7 to 9, the ink dots are recorded on the medium to be recorded 11 by ejecting ink nozzles of predetermined nozzle arrays 112A to 112F based on the test data (S100), and the amount of the position deviation in the sub-scanning direction of the ink dots recorded on the medium to be recorded 11 is measured and the correction amount of the recording timing is calculated (S102). Next, the calculated correction amount is stored into the correction amount storing unit 420 of the controlling unit 49 (S104). Next, the recording timing data is corrected based on the correction amount based on the correction amount storing unit 420 of the inkjet type recording apparatus 10 and the ink dots desired are recorded on the medium to be recorded 11 (S110).

FIG. 11 shows the correction step S110 in detail. First, the recording timing data supposed to be recorded on the medium to be recorded 11 is generated (S112). Next, the data of the color of the generated recording timing data is separated for each color that the recording head 44 has (S114). Next, as described in FIG. 5 and FIG. 6, the recording timing data is corrected based on the correction amount of nozzles of nozzle arrays corresponding to each color (S116). Next, whether the process has been completed for the data of all colors is judged (S118). If the process has not yet been completed for the data of all colors (S118, No), the recording timing data of the next color is corrected (S116).

If the process has been completed for the data of all colors (S118, Yes), whether the process has been completed for the recording timing data of one scanning portion of the carriage 42 is judged (S120). If the process has not yet been completed for the recording timing data of one scanning portion (S120, No), the data of the color of the next pixel is separated (S114). If the process has been completed for the recording timing data of one scanning portion (S120, Yes), the correction data is outputted to the transferring unit 30 and the recording unit 40, and the ink dots are recorded on the medium to be recorded 11 based on the corrected recording timing data (S122). Next, whether the recording has been completed on the medium to be recorded 11 is judged (S124), if the recording has not yet been completed (S124, No), the data of the next color is separated (S114). If the recording has been completed (S124, Yes), process of, e.g. cleaning the recording head 44 is performed after recording is completed (S126). Therefore, by obtaining the correction amount of the recording timing in regard to initial setting before shipment, the position deviation of the recording position of the ink dots in the sub-scanning direction can be corrected during the use of a user. The process of correcting the recording timing shown in FIG. 11 may be performed by the inkjet type recording apparatus 10.

In addition, the process of correcting the recording timing shown in FIG. 11 may be performed by a user with the information processing apparatus 300. If a user corrects the recording position by using the information processing apparatus 300, the information processing apparatus 300 acquires the correction amount stored in the inkjet type recording apparatus 10 and corrects the recording timing data based on the computer program stored in the recording medium 700 or the like, and outputs the corrected recording timing data to the inkjet type recording apparatus 10 in order to perform recording on the medium to be recorded 11. Therefore, a user can correct the recording position by using the information processing apparatus 300 if the looseness of the carriage 42 becomes large during the use of the inkjet type recording apparatus 10.

Although the present invention has been described by way of exemplary embodiments, it should be understood that those skilled in the art might make many changes and substitutions without departing from the spirit and the scope of the present invention, which is defined only by the appended claims.

As obvious from the description above, according to the present invention, it is possible to shift and correct each of the recording positions in advance by correcting the recording timing corresponding to the amount of the position deviation in the sub-scanning direction of nozzles of each of the nozzle arrays 112A to 112F. Thus, even if the carriage 42 is fitted with the guide 48 while it is tilted, recording can be performed on the medium to be recorded 11 in the shape supposed to be recorded without adjusting the carriage 42 mechanically.

What is claimed is:

1. A recording position correction method for correcting position deviation in a sub-scanning direction crossing a main scanning direction of a recording position on a medium to be recorded, wherein an inkjet type recording apparatus performs recording on said medium to be recorded by ejecting ink from a plurality of nozzles while allowing a recording head, on which nozzle arrays comprising said plurality of nozzles provided in said sub-scanning direction are arranged in said main scanning direction, to perform scanning along at least one of forward and backward paths in said main scanning direction, comprising:
an ejection step of ejecting said ink from said plurality of nozzles onto said medium to be recorded;
a measurement step of measuring an amount of position deviation in said sub-scanning direction of an ink dot recorded; and
a correction step of previously shifting and correcting a recording position of an ink dot to be recorded on said material for each of said plurality of nozzles based on said measured amount of said position deviation.

2. A recording position correction method as claimed in claim 1, wherein said ink is ejected from at least one nozzle of each of two nozzle arrays most distanced from each other in said main scanning direction among said plurality of nozzle arrays in said ejection step, and
said recording position of said ink dot to be recorded on said material for each of said plurality of nozzles is previously shifted and corrected based on an amount of position deviation of an ink dot ejected and recorded from said nozzle of said two nozzle arrays in said correction step.

3. A recording position correction method as claimed in claim 2, wherein said ink is further ejected from a nozzle of a nozzle array among said plurality of nozzle arrays except said two nozzle arrays in said ejection step, and
said recording position of said ink dot to be recorded on said material for each of said plurality of nozzles is previously shifted and corrected based on an amount of position deviation of an ink dot ejected and recorded from at least one nozzle of each of said two nozzle arrays and at least one nozzle of said nozzle array except said two nozzle arrays in said correction step.

4. A recording position correction method as claimed in claim 1, wherein said ink is ejected from said plurality of nozzles in order that a color of said ink from each of said nozzle arrays is different from one another in said ejection step, and
said recording position of said ink dot is previously shifted and corrected for each of said colors in said correction step.

5. A recording position correction method as claimed in claim 1, wherein said ink is ejected while said recording head performs scanning along said forward and/or backward path(s) in said main scanning direction in said ejection step, and
said recording position of said ink dot is previously shifted and corrected in said correction step based on an intermediate value between an amount of position deviation of an ink dot ejected and recorded in case said ink is ejected while said recording head performs scanning along said forward path in said main scanning direction and an amount of position deviation of an ink dot ejected and recorded in case said ink is ejected while said recording head performs scanning along said backward path.

6. A recording position correction method as claimed in claim 1, wherein said ink is ejected while said recording head performs scanning along said forward and/or backward path(s) in said main scanning direction in said ejection step, and
correction is performed in said correction step, wherein said recording position of an ink dot to be recorded along said forward path in said main scanning direction is previously shifted based on an amount of position deviation in case said recording head performs scanning along said forward path in said main scanning direction and
said recording position of an ink dot to be recorded along said backward path in said main scanning direction is previously shifted based on an amount of position deviation in case said recording head performs scanning along said backward path in said main scanning direction.

7. A recording position correction method as claimed in claim 1, wherein said ink is ejected from at least one nozzle of each of two nozzle arrays which eject said ink of two colors respectively among said plurality of nozzle arrays as priority is given to a color of which density is highest in said ejection step, and
said recording position of said ink dot to be recorded on said material for each of said plurality of nozzles is previously shifted and corrected based on an amount of position deviation of an ink dot ejected and recorded from said nozzle of said two nozzle arrays in said correction step.

8. An inkjet type recording apparatus for performing recording on said medium to be recorded by ejecting ink from a plurality of nozzles while allowing a recording head, on which nozzle arrays comprising said plurality of nozzles provided in said sub-scanning direction are arranged in said main scanning direction, to perform scanning along at least one of forward and backward paths in said main scanning direction, comprising
a correcting unit for previously shifting and correcting a recording position of an ink dot to be recorded on said material for each of said plurality of nozzles based on an amount of position deviation in a sub-scanning direction crossing said main scanning direction of an ink dot ejected and recorded from said plurality of nozzles.

9. A computer program for correcting position deviation of an ink dot ejected and recorded from a plurality of nozzles in a sub-scanning direction crossing a main scanning direction, wherein an inkjet type recording apparatus performs recording on a medium to be recorded by ejecting ink from said plurality of nozzles while allowing a recording head, on which nozzle arrays comprising said plurality of nozzles provided in said sub-scanning direction are arranged in said main scanning direction, to perform scanning along at least one of forward and backward paths in said main scanning direction, comprising
a correction function of previously shifting and correcting a recording position of an ink dot to be recorded on said material for each of said plurality of nozzles based on an amount of position deviation of an ink dot ejected and recorded from said plurality of nozzles in said sub-scanning direction crossing said main scanning direction.
